(19) United States
(12) Patent Application Publication
(10) Pub. No.: US 2019/0015992 A1
(43) Pub. Date: Jan. 17, 2019

(54) ROBOTIC CONSTRUCTION GUIDANCE

(71) Applicant: FORMDWELL INC, NEW YORK, NY (US)

(72) Inventor: Sa{hacek over (s)}a Jokic, NEW YORK, NY (US)

(21) Appl. No.: 16/032,779

(22) Filed: Jul. 11, 2018

Related U.S. Application Data
(60) Provisional application No. 62/531,265, filed on Jul. 11, 2017.

(51) Int. Cl. B25J 11/00; B25J 9/16; G06F 17/30; G06T 17/00; H04N 5/74

(52) U.S. Cl. CPC B25J 11/00; B25J 9/1679; B25J 9/162; H04N 5/7475; G06F 17/30244; G06T 17/00; B25J 9/1694

(57) ABSTRACT

A system for robotic construction guidance includes a sensor module including one or more sensors. A projection module is rotatably connected to the sensor module and includes one or more projection elements configure to project an image onto a surrounding structure. A base module is rotatably connected to the projection module or the sensor module, and includes a support structure, wheels, and/or a suspension means.

### CROSS REFERENCE TO RELATED APPLICATION

The present application is based on provisional application Ser. No. 62/531,265, filed Jul. 11, 2017, the entire contents of which are herein incorporated by reference.

### TECHNICAL FIELD

The present disclosure relates to construction and, more specifically, to a robot for performing construction guidance and a method of performing construction using the robot.

### DISCUSSION OF THE RELATED ART

Construction is the process of building a structure. Construction is generally performed at the site where the structure is to remain, rather than at a factory in which working conditions may be more effectively controlled. Additionally, construction generally requires a variety of tasks that are performed by various skilled professionals and laborers. Accordingly, there is a great deal of logistical planning that goes into construction, as the proper workers need access to the worksite at different times.

Construction plans are generally provided; however, it is often time consuming for the various workers to extract the information they require from the construction plans, and understanding where within the three-dimensional jobsite tasks need to be performed from the two-dimensional construction plans is often a difficult and error prone endeavor. Accordingly, much of the time spent on construction is spent on determining where and how work needs to be done rather than actually performing the construction work.

### SUMMARY

A system for robotic construction guidance includes a sensor module including one or more sensors. A projection module is rotatably connected to the sensor module and includes one or more projection elements configure to project an image onto a surrounding structure. A base module is rotatably connected to the projection module or the sensor module, and includes a support structure, wheels, and/or a suspension means.

A database may be configured to store one or more BIM 3D models and a central processing unit CPU may be configured to read the one or more BIM 3D models from the database and to project the BIM 3D models onto the surrounding structure using the one or more projection elements.

The projection module may include a frame and a projection swing mount that is rotatably connected within the frame. The one or more projection elements may be disposed on the projection swing mount.

The base module may include the support structure and the support structure may include one or more feet for standing the system on a floor.

The base module may include the wheels and the wheels may be configured to drive the system around an environment.

The base module may include the suspension means and the suspension means may be configured to attach the system to a guide wire or railing and to move the system along the guide wire or railing,

A first servo may be configured to rotate the sensor module about the projection module. A second servo may be configured to rotate the projection elements about the projection module. A third servo may be configured to rotate the projection module about the base module.

The sensor module may be configured to determine a location and/or orientation of the system within an environment and the projection module may be configured to project the image onto the surrounding structure according to the determined location and position.

A radio may be configured to communicate with an external processing apparatus that is configured to read one or more BIM 3D models from a database and to control the projection module to project the BIM 3D models onto the surrounding structure.

A short range communications radio may be in communication with an external remote control module. The remote control module may be configured to select one or more BIM 3D models from a database and to control the projection module to project the BIM 3D models onto the surrounding structure.

A method for robotic construction guidance includes accessing a database of BIM 3D models and loading a construction plan therefrom, the construction plan including a plurality of steps, scanning an environment and modeling the environment based on the scan, projecting instructions for completing a first step of the plurality of steps onto the environment, scanning the environment to determine when the first step has been completed, and projecting instructions for completing a second step of the plurality of steps onto the environment when it has been deter ruined that the first step has been completed. Projecting the instructions for completing the first and second steps includes projecting an image indicating work to be performed on a structure within the environment at which the work is to be performed.

An issue detection step may be performed either before or after the first step has been completed. The issue detection step may include assessing quality, detecting defects in structure or aesthetics, detecting missing components, detecting deviations, and/or detecting missing design features.

A robotic construction guide includes a sensor module having one or more sensors and one or more cameras and the robotic construction guide is configured to scan and model a surrounding environment. A central processing unit is configured to read a construction plan from a database and to interpret the performance of the construction plan within the modeled environment. A projection module is configured to project instructions for performing the construction plan within the modeled environment by projecting guidance onto a structure within the environment where work is to be performed. A base module is configured to move the construction guide within the environment.

The sensor module may be rotatable with respect to the base module by a first servo under the control of the CPU and the projection module may be rotatable with respect to the base module by a second servo under the control of the CPU.

The projected guidance may include an indication of what work is to be done at a location on the structure that the guidance is projected upon.

The base module may include two or more wheels.

The base module may include two or more feet.

The projection module may include a laser projector.

The projection module may include a digital image projector.

The one or more sensors may include a lidar sensor, a temperature sensor, a chemical thread detection sensor, a noise/vibration sensor, a particle sensor, a humidity sensor, or a light sensor.

The one or more cameras may include two camera modules for capturing binocular images.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram illustrating a robot for performing construction guidance in accordance with exemplary embodiments of the present invention;

FIG. 2 is a diagram illustrating an alternate configuration of the robot according to an exemplary embodiment of the present intention;

FIG. 3 is a diagram illustrating an inverted configuration of the robot according to an exemplary embodiment of the present intention;

FIG. 4 is a schematic diagram illustrating various components of the construction support robot in accordance with exemplary embodiments of the present invention;

FIG. 5 is a flow chart illustrating a method for using a construction assistance robot in accordance with exemplary embodiments of the present invention;

FIG. 6 is an image showing the construction assistance robot mounted in a stationary manner on a floor of a construction site in accordance with exemplary embodiments of the present invention;

FIG. 7 is a schematic diagram illustrating a mobile variant of the construction assistance robot in accordance with exemplary embodiments of the present invention;

FIG. 8 is an image showing a fully automated variant of the construction assistance robot in accordance with exemplary embodiments of the present invention;

FIG. 9 is an image showing a fully automated variant of the construction assistance robot in accordance with exemplary embodiments of the present invention;

FIG. 10 is a schematic diagram illustrating a mobile variant of the construction assistance robot in accordance with exemplary embodiments of the present invention.;

FIG. 11 is a schematic diagram illustrating a mobile variant of the construction assistance robot in accordance with exemplary embodiments of the present invention;

FIG. 12 is a schematic diagram illustrating a mobile variant of the construction assistance robot in accordance with exemplary embodiments of the present invention;

FIG. 13 is a schematic diagram illustrating a drone variant of the construction assistance robot in accordance with exemplary embodiments of the present invention; and

FIG. 14 is a schematic diagram illustrating an approach for performing manual alignment and registration of projected construction guidance in accordance with exemplary embodiments of the present invention.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention utilize robotic construction guidance to aid in the performance of construction. This approach utilizes a computer-controlled robot equipped with various sensors for observing a construction site. The computer controller may use the sensor data to generate a three-dimensional model of the environment, or to fit the environment to an existing three-dimensional model. Construction plans may be interpreted by the computer controller, in light of the three-dimensional model. The construction plans may include, for example, a Building Information Modeling (BIM) 3D model. A next task to be performed may be determined, either by the computer controller or by construction personnel. The robot may include various projectors and/or laser diode pointing/drawing device which may project, upon surfaces of the construction site, instructions for where the task needs to be performed. In this way, various workers at the jobsite may be shown exactly where work needs to be performed so that less time need be spent on interpreting construction plans/RIM 3D models and more time may be spent on actually performing the construction tasks.

The construction assistance robot may also be configured as a surveying apparatus and may additionally be able to automatically perform worksite surveying, which may be used to help perform subsequent construction tasks.

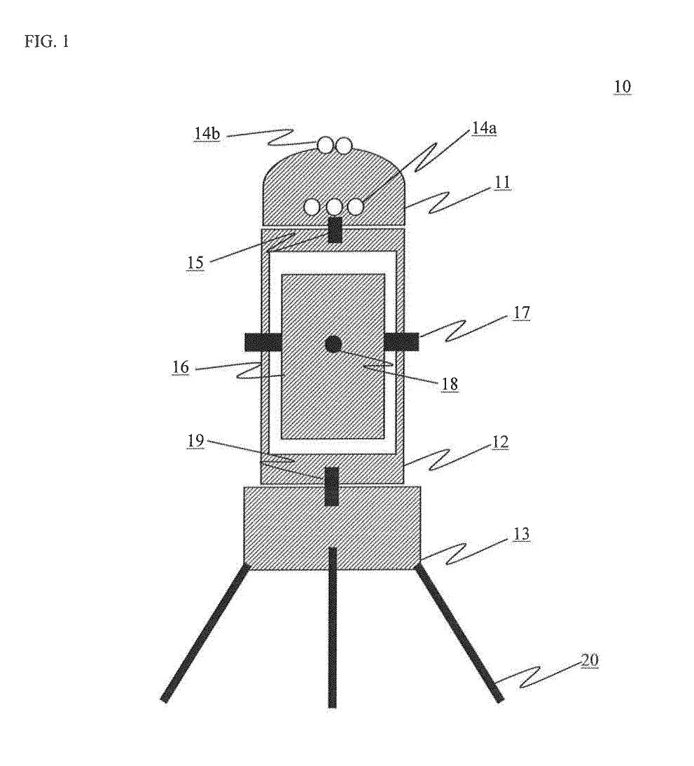

The robot may accordingly include various elements. FIG. 1 is a schematic diagram illustrating a robot for performing construction guidance in accordance with exemplary embodiments of the present invention. The robot 10 may include various operational elements such as a sensor module 11, a projection module 12, and a base module 13. The sensor module may incorporate various sensors 14a such as lidar sensors, temperature sensors, chemical thread detection sensors, noise/vibration sensors, particle sensors, humidity sensors, light sensors, etc. The sensor module 11 may also include one or more camera modules 14b, The camera modules 14b may be configured to acquire 360° images by incorporating one or more wide-angle lenses. However, the camera modules may alternately have an angular domain that is less than 360°. The camera module 14b may incorporate pairs of lenses so as to acquire binocular images so that the camera modules may acquire depth information.

The sensor module 11 may be connected to the projection module 12 by a rotational servo motor 15 so that the sensor module 11 may be rotated with respect to the projection module so that the camera modules 14b and various sensors 14a may be centered to a desired angle, particularly where the camera modules 14b have an angular domain that is less than 360°. The sensor module 11 may be alternatively or additionally connected to the projection module 12 such that the pitch of the sensor module 11 may be changed so that the camera modules 14b and the various sensors 14a may be pointed up and down. In this way, any desired solid angle of the sensor module may be achieved.

The projection module 12 may have an open cavity in its center within which a projection swing mount 16 is installed. The projection swing mount 16 may rotate within the projection module 12 and may be rotated therein by a rotational servo motor 17. The projection swing mount 16 may include one or more laser or LED projector elements 18, and various optical elements used thereby. The laser or LED projector elements 18 may be configured to project images upon remote surfaces. The projection module 12 may be rotatably connected to the base module 13 and a rotational servo motor 19 may be used to control the rotation of the projection module with respect to the base module. In this way, the various servo motors may allow the laser/LED projector elements 18 to be directed to an arbitrary solid angle so that images may be projected therefrom to any desired surface. The various rotational servo motors 17 and 19 may operate in high speed to allow for the laser/LED projector element 18 to scan a projected image onto surfaces of the construction site.

The base module 13 may house a battery pack, as will be described in additional detail below, as well as various other electronic elements. Elements to support the base module 13 on the floor, attach the base to a ceiling or any other structure, or to provide displacement/locomotion may be included and, for example, attached to the base module 13. For example, a support structure 20 may be used to allow the robot 10 to rest securely on the floor of the jobsite or some other surface thereof.

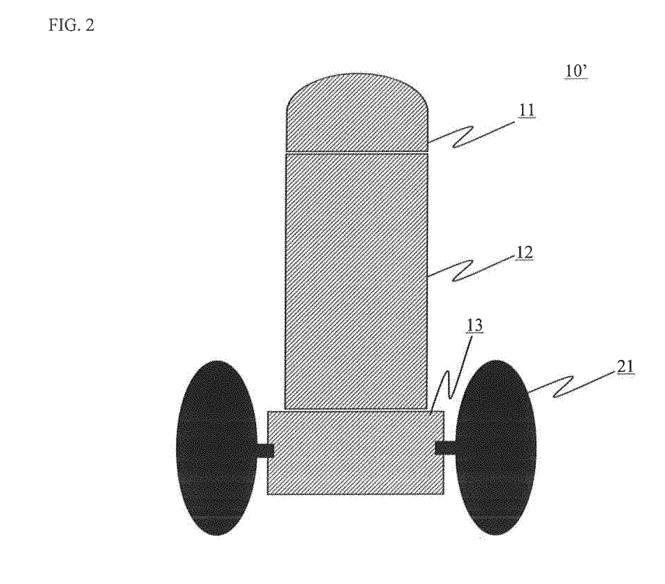

FIG. 2 is a diagram illustrating an alternate configuration of the robot 10′ according to an exemplary embodiment of the present intention. As illustrated here, two or more motorized wheels 21 may be affixed to the robot 10′, for example, at its base module 13. The wheels 21 may be turned together to move the robot 10′ forward or backwards, and the wheels 21 may be turned in opposite directions to allow the robot to turn. For added stability, there may be more than two wheels 21, for example, three or four wheels 21, and/or a gyroscope may be incorporated into the robot to provide added stability while in motion or at rest. Other elements such as supports or kickstands may be used and the various wheels, supports or kickstands may be retractable and extendable.

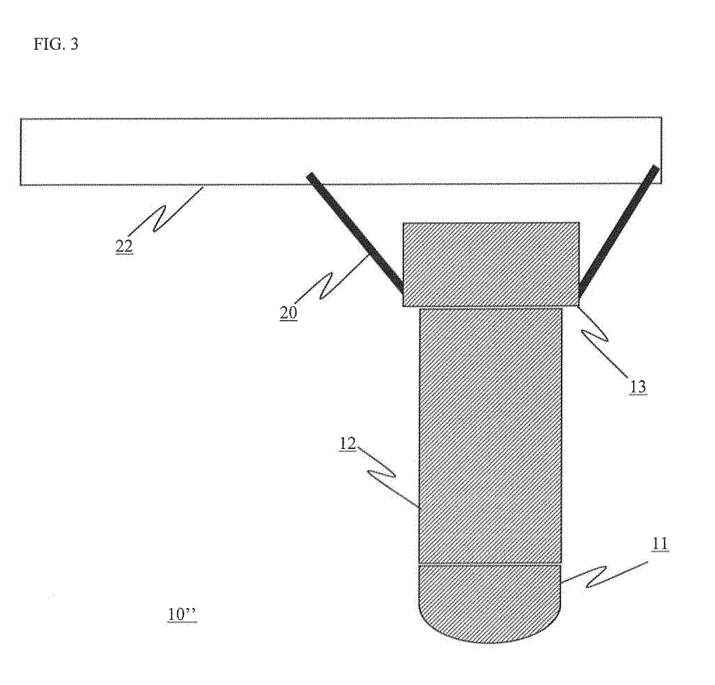

FIG. 3 is a diagram illustrating an inverted configuration of the robot 10″ according to an exemplary embodiment of the present intention. Here the robot 10″ may be mounted in an inverted manner to a construction beam, ceiling, or other structure 22 using one or more support structures 20, suction cups, magnets, straps, etc. The robot 10″ may also be configured to be mounted along a rail or cables so that the robot 10″ may move itself therealong to achieve a desired position.

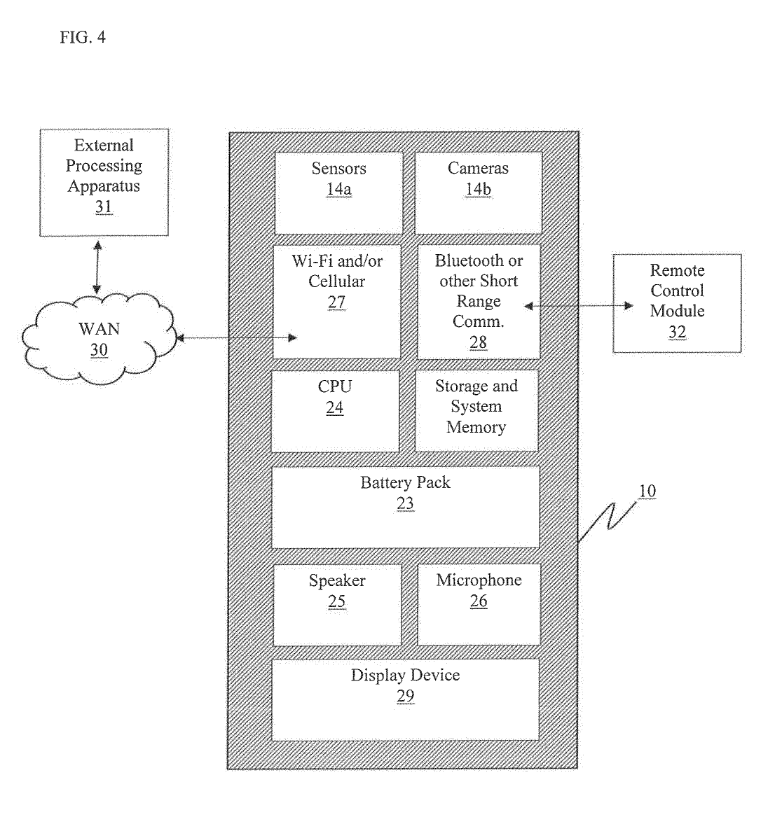

FIG. 4 is a schematic diagram illustrating various components of the construction support robot in accordance with exemplary embodiments of the present invention. The construction support robot 10 may include sensors 14a and cameras 14b, as described above. As mentioned above, the construction support robot 10 may include a batter pack 23 as well as associated charging and power circuitry so that the construction support robot 10 may be recharged and/or powered by a wired connection, The construction support robot 10 may further include a central processing unit (CPU) and/or a graphics processing unit (GPU) and/or various other processors and co-processors 24. The CPU 24 may perform the function of controlling the movements (e.g. rotational and locomotive movements) of the construction support robot 10. receiving sensor/image data, modeling the construction site, interpreting the BIM 3D model, and controlling the projection elements to cast the desired instructional displays on the various surfaces of the construction site.

The CPU 24 may also control a speaker 25 to issue audible instructions and control the microphone 26 to receive voice commands. The CPU 24 may interpret the voice commands using an artificial intelligence (AI) programming module. One or more of the functions of the CPU 24 may be performed by an external processing apparatus 31 which may be in communication with the CPU over a wide area network (WAN) 30 such as the Internet. In this way, one or more of the processing functions of the construction assistance robot may be performed by a cloud-based service.

The construction assistance robot 10 may include various communications radios such as a Wi-Fi and/or cellular radio 27. Bluetooth or other short-range communications radios 28 may be incorporated into the construction assistance robot 10, for example, to communicate with a remote-control module 32 or smart tools, etc.

The construction assistance robot 10 may additionally include a display device 29, such as an LCD panel and/or touch-screen device so that a user may receive additional information from the construction assistance robot.

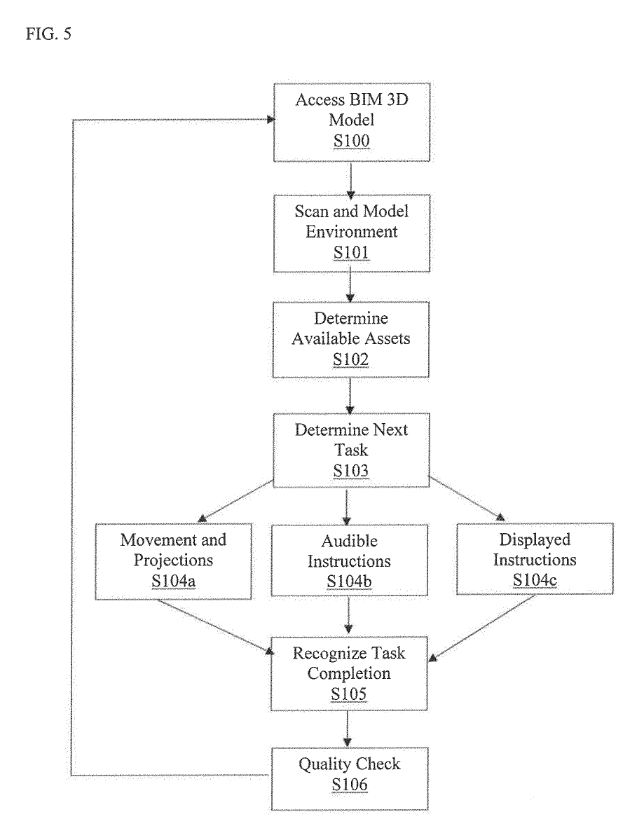

FIG. 5 is a flow chart illustrating a method for using a construction assistance robot in accordance with exemplary embodiments of the present invention. The BIM 3D model may first be accessed by the construction assistance robot (Step S100). This may be performed by instructing the construction assistance robot to load the desired BIM 3D model. This may be performed automatically, for example, using a GPS radio within the construction assistance robot to identify a location of the construction assistance robot and then automatically load up the correct BIM 3D model by location. The BIM 3D model may be loaded from either local storage or over the WAN. The BIM 3D model may alternatively be manually loaded on the request of a user using either a voice user interface, a touch-screen user interface, or a gesture user interface.

The construction assistance robot may then scan the construction site (using sensors and/or cameras) (Step S101) to either generate the 3D model of the environment or to fit the environment to a pre-existing 3D model associated with the BIM 3D model.

The scanning and modeling of this step may include performing segmentation and 3D mapping. Exemplary embodiments of the present invention may provide highly sophisticated data structures and processing of the 3D scans, enabling the performance of segmentation, feature estimation and surface reconstruction. Machines learning may be utilized to identify all visible structural components at the construction site environment (e.g. walls, floors, ceilings, windows, and doorways) from the scan, despite the presence of significant clutter and occlusion, which occur frequently in natural indoor environments.

The construction assistance robot may then determine which assets are presently available (Step S102). The assets may include available workers, available tools, available supplies, etc. Assets present at the worksite may be automatically recognized by computer vision or by sensors, for example, by incorporating identifiers such as barcodes, near field communications (NFC) chips, or the like, onto the assets. For example, workers may be identified by facial recognition or by NFC/barcode nametags. Similarly, tools and supplied may be identified by computer vision and/or NFC/barcode tags. The availability of assets may alternatively be determined by accessing various personnel and other databases. In such cases, availability may be confirmed by computer vision/NFC as discussed above. Moreover, the databases may be used to determine for how long identified assets will remain present and available at the jobsite.

Next, the construction assistance robot may determine a task to perform by taking into account the available assets, the length of time for which the assets will remain available, the present state of construction progress, etc. (Step S103). Then the construction assistance robot may provide work instructions for performing the determined task (Step S104). This may include projecting guidance onto the surrounding structures (Step S104a), providing audible instructions (Step S104b), and/or displaying instructions to either an incorporated display panel or on worker's handheld devices (Step S104c).

Projecting guidance may include moving the construction assistance robot to an appropriate position, where needed, or instructing users to provide the required positioning. Then the rotational servos, etc. may be controlled to provide the required orientation. Then the required instructional imagery may be projected, for example, using the laser/LED projectors. The projections may include designating marks to show where worker action is to be performed and may also include writing projected next to the designating marks to explain what action needs to be performed by the workers. The needed assets may also be illuminated, including the equipment, supplies, and even people. Notification of the people may alternatively or additionally be performed by text message or signaling a wearable device worn by the workers to light up, vibrate, display text, etc.

For example, where the task to be performed is to install wiring on wall frames, the location of the junction boxes may be marked with a square and the location for the wires to be run may be marked by connecting lines. The markers may in this way project elements onto the wall frames that resemble the actual elements the workers are to install at those locations.

The construction assistance robot may thereafter recognize when the task is completed (Step S105) and may then repeat the process for the next task. Additionally, the construction assistance robot may perform a quality check (Step S106) by examining the work performed (e.g. using computer vision) and identifying where work may have been performed incorrectly. In the event work is done incorrectly, the next task assigned by the construction assistance robot would be to remediate the problem. Where the quality check is passed, or after the remediation task has been performed, available assets will be determined again and the next task determined.

The quality check (Step S106) may include issue detection, in performing issue detection, exemplary embodiments of the present invention may use 3D scanned environment data and 3D-generated models to assess issues with quality control, such as defects in execution (both structural and aesthetic) and early detection of critical events (e.g., pillar failure, cracks, missing components, deviations, missing design features). Issue detection need not be performed at this step and may be performed at any point within the robotic construction guidance process.

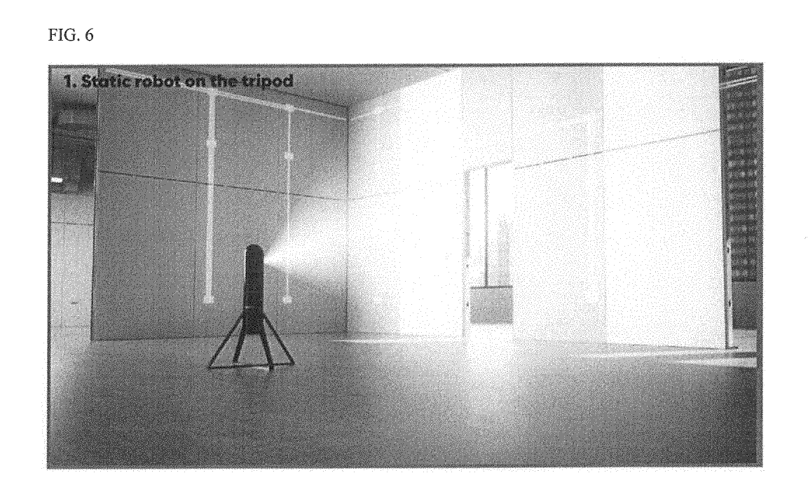

FIG. 6 is an image showing the construction assistance robot mounted in a stationary manner on a floor of a construction site in accordance with exemplary embodiments of the present invention. As can be seen, the construction assistance robot is projecting designating marks on the walls.

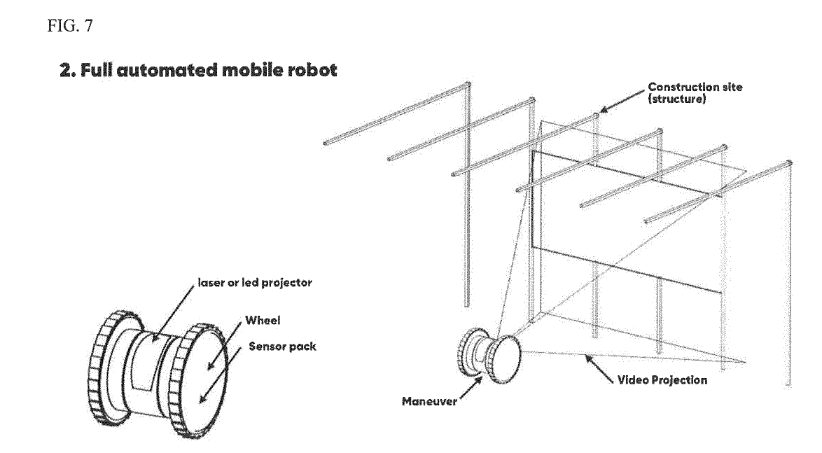

FIG. 7 is a schematic diagram illustrating a mobile variant of the construction assistance robot in accordance with exemplary embodiments of the present invention. As can be seen, the construction assistance robot, here captioned “Maneuver” includes two wheels and is able to project a video image on a construction site structure.

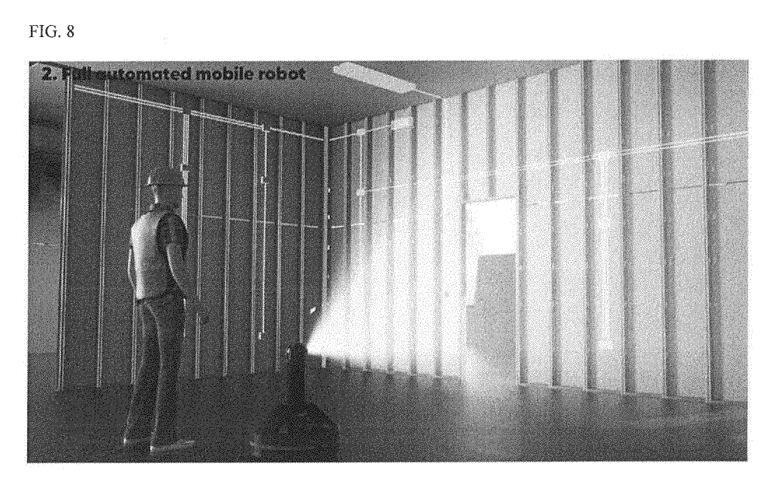

FIG. 8 is an image showing a fully automated variant of the construction assistance robot in accordance with exemplary embodiments of the present invention. Here the construction assistance robot includes a mobile base. As can be seen, the construction assistance robot is projecting designating marks on the walls and ceiling.

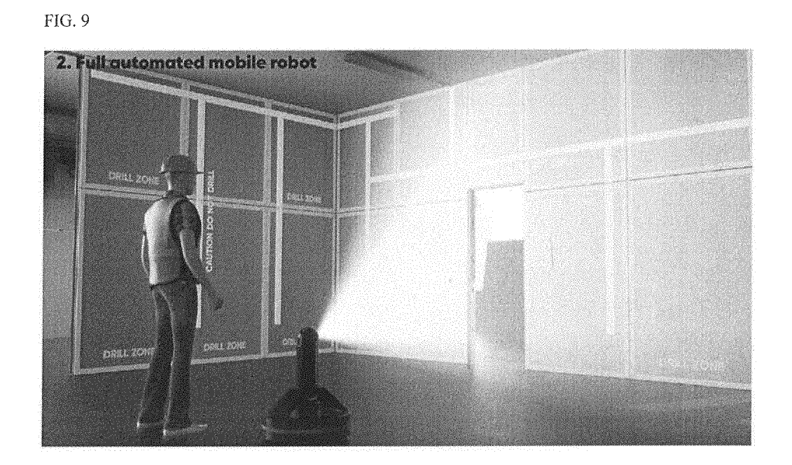

FIG. 9 is an image showing a fully automated variant of the construction assistance robot in accordance with exemplary embodiments of the present invention. Here the construction assistance robot includes a mobile base. As can be seen, the construction assistance robot is projecting designating marks and instructive text on the walls.

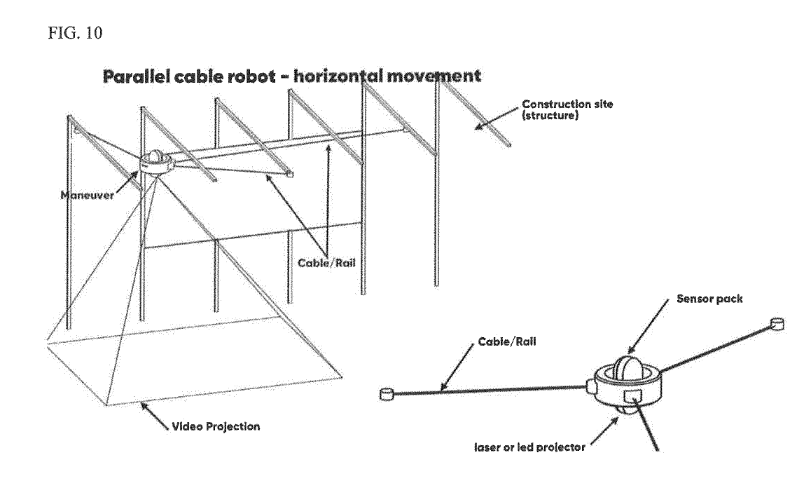

FIG. 10 is a schematic diagram illustrating a mobile variant of the construction assistance robot in accordance with exemplary embodiments of the present invention. As can be seen, the construction assistance robot, here captioned “Maneuver” is mounted on various cables and/or rails which are connected to structure of the construction site including horizontal structures. The construction assistance robot may move along the cables/rails and may project images, for example, to the floor.

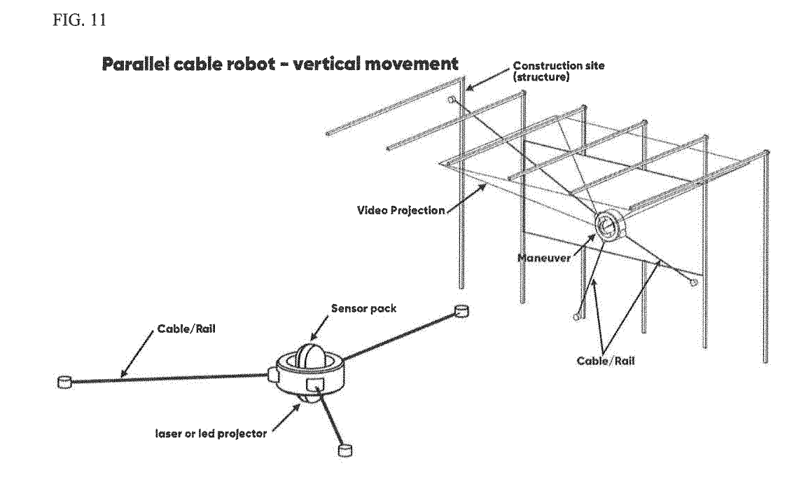

FIG. 11 is a schematic diagram illustrating a mobile variant of the construction assistance robot in accordance with exemplary embodiments of the present invention. As can be seen, the construction assistance robot, here captioned “Maneuver” is mounted on various cables and/or rails which are connected to structure of the construction site including horizontal and vertical structures. The construction assistance robot may move along the cables/rails and may project images, for example, to the walls.

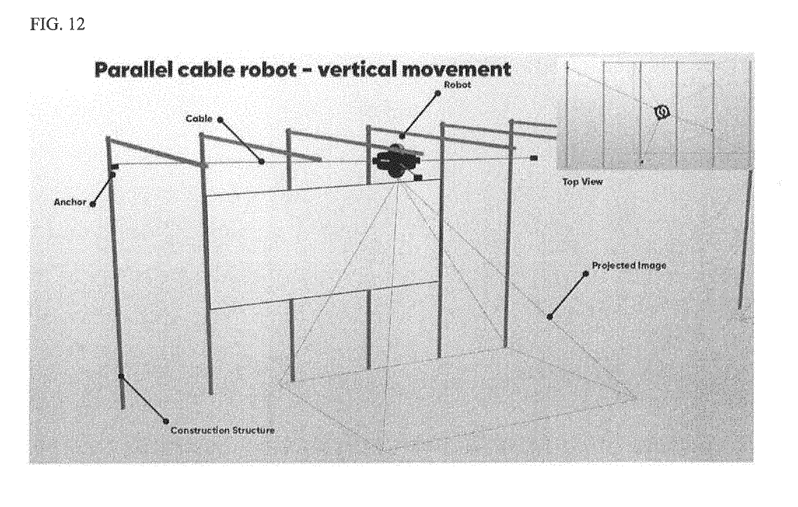

FIG. 12 is a schematic diagram illustrating a mobile variant of the construction assistance robot in accordance with exemplary embodiments of the present invention. As can be seen, the construction assistance robot, here captioned “Robot” is mounted on a set of cables which are anchored to various locations of the construction site, not necessarily the construction structure. The construction assistance robot may move along the cables and may project images, for example, to the floor.

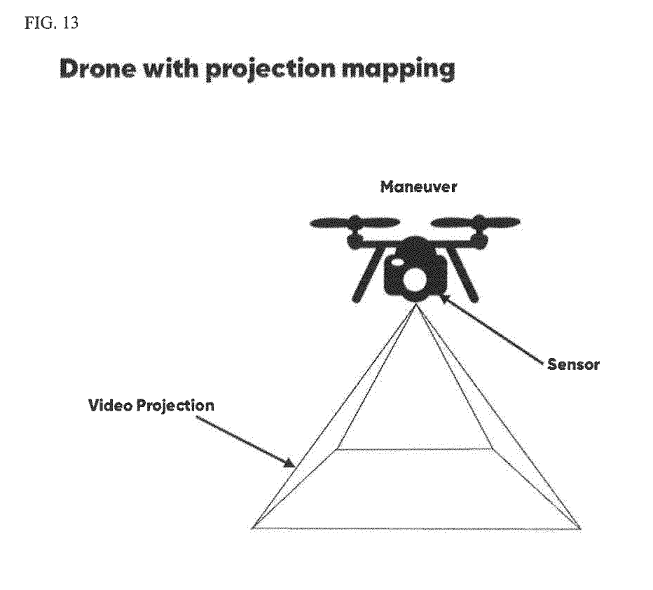

FIG. 13 is a schematic diagram illustrating a drone variant of the construction assistance robot in accordance with exemplary embodiments of the present invention. As can be seen, the construction assistance robot, here captioned “Maneuver” flies above the construction site and projects images therebelow.

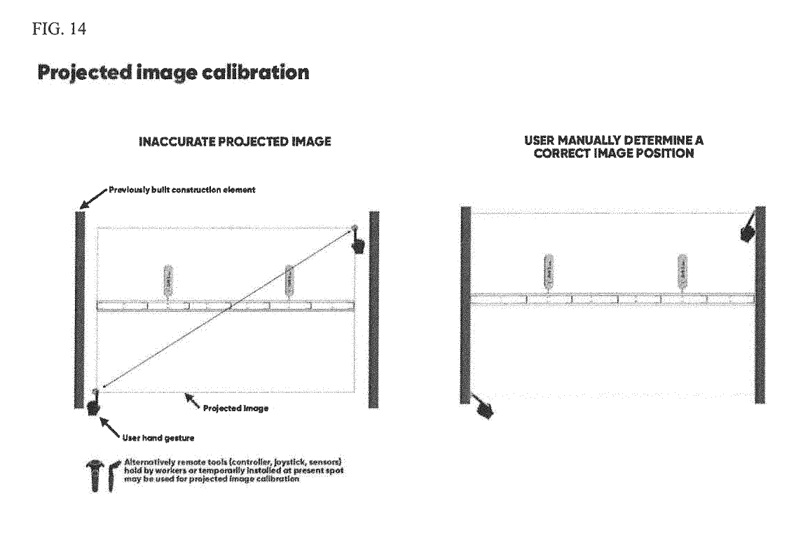

It is understood that the possibility exists for the construction assistance robot to project guidance imagery upon the site structures in such a way that the imagery does not fully align with the structures. For example, guidance imagery illustrating where to mount electrical conduits within a wall might not accurately reflect the size of the wall. According to some exemplary embodiments of the present invention, such an alignment error may be automatically corrected, for example, in the quality check and remediation step discussed above. However, exemplary embodiments of the present invention may also allow for a human user to manually adjust alignment and registration. FIG. 14 is a schematic diagram illustrating an approach for performing manual alignment and registration of projected construction guidance in accordance with exemplary embodiments of the present invention. As shown, the user may observe an inaccuracy in registration/alignment as the projected guidance might not appear to fully match the site structures. This may be more easily observed, for example, by the construction assistance robot projecting alignment elements upon the worksite structures. Alignment elements may include projecting shapes upon structures known to exist so that alignment/registration may be easily ascertained. The human user may adjust the alignment/registration, for example, by hand gesture. According to one such approach, the user may use a hand gesture to “touch” an area of the projection (such as a line or corner of the projected image) and then “move” the area to the desired location in a form of drag-and-drop action. The construction assistance robot may recognize the hand gestures of the user and adjust the alignment/registration accordingly. Alternatively, or additionally, the user may use a remote-control device such as a controllers, joystick, senor, etc. to adjust the alignment/registration.

What is claimed is:

1. A system for robotic construction guidance, comprising:
a sensor module including one or more sensors;
a projection module, rotatably connected to the sensor module, including one or more projection elements configure to project an image onto a surrounding structure; and
a base module rotatably connected to the projection module or the sensor module, and including a support structure, wheels, and/or a suspension means.

2. The system of claim 1, further comprising:
a database configured to store one or more Building Information Modeling (BIM) 3D models; and
a central processing unit CPU configured to read the one or more 3D models from the database and to project the BIM 3D models onto the surrounding structure using the one or more projection elements.

3. The system of claim 1, wherein the projection module comprises a frame and a projection swing mount that is rotatably connected within the frame, wherein the one or more projection elements are disposed on the projection swing mount.

4. The system of claim 1, wherein the base module includes the support structure and the support structure includes one or more feet for standing the system on a floor.

5. The system of claim 1, wherein the base module includes the wheels and the wheels are configured to drive the system around an environment.

6. The system of claim 1, wherein the base module includes the suspension means and the suspension means is configured to attach the system to a guide wire or railing and to move the system along the guide wire or railing.

7. The system of claim 1, further comprising:
a first servo configured to rotate the sensor module about the projection module;
a second servo configured to rotate the projection elements about the projection module; and
a third servo configured to rotate the projection module about the base module.

8. The system of claim 1, wherein the sensor module is configured to determine a location and/or orientation of the system within an environment and the projection module is configured to project the image onto the surrounding structure according to the determined location and position.

9. The system of claim 1, farther comprising a radio configured to communicate with an external processing apparatus that is configured to read one or more BIM 3D models from a database and to control the projection module to project the BIM 3D models onto the surrounding structure.

10. The system of claim 1, further comprising a short range communications radio in communication with an external remote control module, the remote control module configured to select one or more BIM 3D models from a database and to control the projection module to project the BIM 3D models onto the surrounding structure.

11. A method for robotic construction guidance, comprising:
accessing a database of Building Information Models (BIM) 3D models and loading a BIM 3D model therefrom, the BIM 3D model including a plurality of steps;
scanning an environment and modeling the environment based on the scan;
projecting instructions for completing a first step of the plurality of steps onto the environment;
scanning the environment to determine when the first step has been completed; and
projecting instructions for completing a second step of the plurality of steps onto the embodiment when it has been determined that the first step has been completed,
wherein projecting the instructions for completing the first and second steps includes projecting an image indicating work to be performed on a structure within the environment at which the work is to be performed.

12. The method of claim 11, further comprising performing an issue detection step, either before or after the first step has been completed, the issue detection step including assessing quality, detecting defects in structure or aesthetics, detecting missing, components, detecting deviations, and/or detecting missing design features.

13. A robotic construction guide, comprising:
a sensor module including one or more sensors and one or more cameras and configured to scan and model a surrounding environment;
a central processing unit configured to read a construction plan front a database and to interpret the performance of the construction plan within the modeled. environment;
a projection module configured to project instructions for performing the construction plan within the modeled environment by projecting guidance onto a structure within the environment where work is to be performed; and
a base module configured to move the construction guide within the environment.

14. The robotic construction guide of claim 13, wherein the sensor module is rotatable with respect to the base module by a first servo under the control of the CPU and the projection module is rotatable with respect to the base module by a second servo under the control of the CPU.

15. The robotic construction guide of claim 13, wherein the projected guidance includes an indication of what work is to be done at a location on the structure that the guidance is projected upon.

16. The robotic construction guide of claim 13, wherein the base module includes two or more wheels or feet.

17. The robotic construction guide of claim 13, wherein the projection module includes a laser projector.

18. The robotic construction guide of claim 13, wherein the projection module includes a digital image projector.

19. The robotic construction guide of claim 13, wherein the one or more sensors include a lidar sensor, a temperature sensor, a chemical thread detection sensor, a noise/vibration sensor, a particle sensor, a humidity sensor, or a light sensor.

20. The robotic construction guide of claim 13, wherein the one or more cameras include two camera modules for capturing binocular images.
